(19) United States
(12) Patent Application Publication
(10) Pub. No.: US 2026/0159147 A1
(43) Pub. Date: Jun. 11, 2026

(54) COLLAPSIBLE WAGON STROLLER

(71) Applicant: SUMMER INFANT (USA), INC., Woonsocket, RI (US)

(72) Inventors: Dana E. CHICCA, Somerset, MA (US); Sean FOSTER, West Warwick, RI (US); Robert BLACKADAR, Worcester, MA (US)

(21) Appl. No.: 18/706,380

(22) PCT Filed: Oct. 31, 2022
(86) PCT No.: PCT/US2022/079001

§ 371 Date: Apr. 30, 2024

Related U.S. Application Data
(60) Provisional application No. 63/274,819, filed on Nov. 2, 2021.

(51) Int. Cl. B62B 7/08; B62B 7/06; B62B 9/20

(52) U.S. Cl. CPC B62B 7/086; B62B 7/064; B62B 9/20

(57) ABSTRACT

A stroller having a wagon-like configuration. The stroller includes a frame having a collapsible member configured to facilitate an inwardly side-to-side folding of the stroller, and a foldable receptable body held by the frame. The foldable receptable body including a sidewall that defines a wagon-like space. The stroller is movable between (1) a fully open position, (2) a partially-open position, and (3) a fully closed/folded position.

### RELATED APPLICATION

This application claims the benefit of priority to U.S. Provisional Ser. No. 63/274,819 , filed Nov. 2, 2021, the disclosure of which is incorporated by reference herein in its entirety.

### FIELD OF THE INVENTION

The invention relates to strollers, and more particularly, to strollers with collapsible frames/constructions.

### BACKGROUND OF THE INVENTION

Strollers with collapsible frames/constructions are known. It is desirable to have such a stroller that also functions as a wagon.

### SUMMARY

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In one aspect, the invention includes a stroller comprising a frame including a collapsible member, the collapsible member having a front portion and a rear portion; and a foldable receptable body held by the frame. The stroller is movable between (1) a fully open position, (2) a partially-open position, and (3) a fully closed/folded position.

In another aspect, the invention includes a stroller comprising a frame including a collapsible member configured to facilitate an inwardly side-to-side folding of the stroller, the collapsible member having a segmented front portion and a segmented rear portion; and a foldable receptable body held by the frame, the foldable receptable body including a sidewall that defines a wagon-like space. The stroller is movable between (1) a fully open position, (2) a partially-open position, and (3) a fully closed/folded position.

In another aspect, the invention includes a stroller comprising a frame including a collapsible member configured to facilitate an inwardly side-to-side folding of the stroller, the collapsible member having a segmented front portion and a segmented rear portion; a foldable receptable body held by the frame, the foldable receptable body including a sidewall that defines a wagon-like space; and a handle assembly attached to the frame, the handle assembly being configured to pull the stroller. The stroller is movable between (1) a fully open position, (2) a partially-open position, and (3) a fully closed/folded position.

These and other features, aspects, and advantages of the present invention will become better understood with reference to the following description, appended claims, and accompanying drawings.

### BRIEF DESCRIPTION OF THE DRAWINGS

Embodiments of the invention are further described but are in no way limited by the following illustrations.

FIG. 1 shows a top perspective view of a wagon stroller according to a first embodiment of the invention in an open position;

FIG. 2 shows a view of the wagon stroller of FIG. 1 being folded from an open position to a closed position;

FIG. 3 shows a top perspective view of the wagon stroller of FIG. 1 in a closed (i.e., folded) position;

FIG. 4 shows a top perspective view of a wagon stroller according to a second embodiment of the invention and having a handle assembly, wherein the handle assembly in a stowed position;

FIG. 5 shows a top perspective view of the wagon stroller of FIG. 4, wherein the handle assembly is in a partially deployed position;

FIG. 6 shows a top perspective view of the wagon stroller of FIG. 4, wherein the handle assembly is in a fully deployed position;

FIG. 7 shows a top perspective view of a wagon stroller according to a third embodiment of the invention and having a handle assembly;

FIG. 8a shows a top perspective view of a wagon stroller according to a fourth embodiment of the invention and having a handle assembly, wherein the handle assembly is in a partially deployed position;

FIG. 8b shows a top perspective view of the wagon stroller of FIG. 8a, wherein the handle assembly is in a fully deployed position;

FIG. 9 shows a top perspective view of a wagon stroller according to a fifth embodiment of the invention and having a handle assembly, wherein the handle assembly is in a stowed position;

FIG. 10 shows a top perspective view of the wagon stroller of FIG. 9, wherein the handle assembly is in a partially deployed position; and

FIG. 11 shows a top perspective view of the wagon stroller of FIG. 9, wherein the handle assembly is in a fully deployed position.

### DETAILED DESCRIPTION OF THE INVENTION

For convenience, the meaning of some terms and phrases used in the specification, examples, and appended claims, are provided below. Unless stated otherwise, or implicit from context, the following terms and phrases include the meanings provided below. The definitions are provided to aid in describing particular embodiments, and are not intended to limit the claimed invention, because the scope of the invention is limited only by the claims. Unless otherwise defined, all technical and scientific terms used herein have the same meaning as commonly understood by one of ordinary skill in the art to which this invention belongs. If there is an apparent discrepancy between the usage of a term in the art and its definition provided herein, the definition provided within the specification shall prevail.

As used in this specification and the appended claims, the singular forms “a,” “an” and “the” include plural referents unless the content clearly dictates otherwise. For example, reference to “a cell” includes a combination of two or more cells, and the like.

As used herein, the term “approximately” or “about” in reference to a value or parameter are generally taken to include numbers that fall within a range of 5%, 10%, 15%, or 20% in either direction (greater than or less than) of the number unless otherwise stated or otherwise evident from the context (except where such number would be less than 0% or exceed 100% of a possible value). As used herein, reference to “approximately” or “about” a value or parameter includes (and describes) embodiments that are directed to that value or parameter. For example, description referring to “about X” includes description of “X”.

As used herein, the term “or” means “and/or.” The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, the term “comprising” means that other elements can also be present in addition to the defined elements presented. The use of “comprising” indicates inclusion rather than limitation.

The term “consisting of” refers to compositions, methods, and respective components thereof as described herein, which are exclusive of any element not recited in that description of the embodiment.

Disclosed herein are strollers (e.g., for infants and toddlers) that has a collapsible frame/construction and a wagon function/mode.

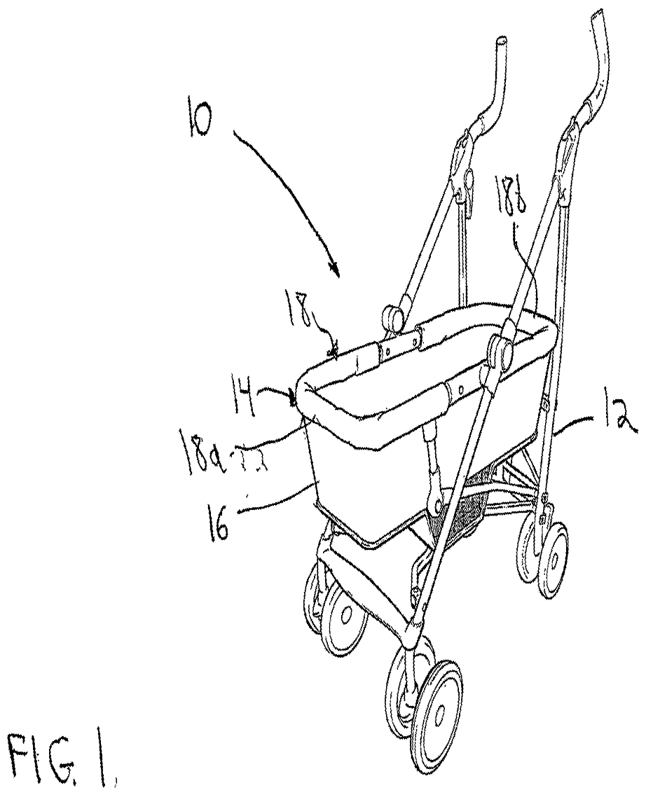

Embodiments of the wagon stroller include “3D strollers” having a 3D collapsing feature, and are capable of being moved between (1) a fully open position, (2) a partially-open, or mid-closed position, and (3) a fully closed/folded position (see FIGS. 1-3). In one embodiment, the stroller constitutes a folding stroller trifold.

As shown in FIGS. 1-3, a first embodiment of the wagon stroller 10 includes a collapsing frame 12 and a foldable receptacle body/containment structure 14 held by the frame 12 and having a generally oblong or rounded rectangular sidewall 16.

The frame 12 includes an integrated collapsible member 18 proximate the sidewall 16, as shown in FIGS. 1-3. In various embodiments, the collapsible member 18 is flexible. In various embodiments, the collapsible member 18 is foldable. In various embodiments, portions of the collapsible member 18 (i.e., front and rear portions 18a, 18b) are segmented, which facilitates the folding function of the collapsible member 18. In other embodiments, the collapsible member 18 is not segmented.

FIGS. 1-3 show the wagon stroller in operation, as discussed further below.

FIG. 1 shows the wagon stroller 10 in an open position, wherein an infant/toddler/child and/or other cargo is receivable in the receptacle body/containment structure 14.

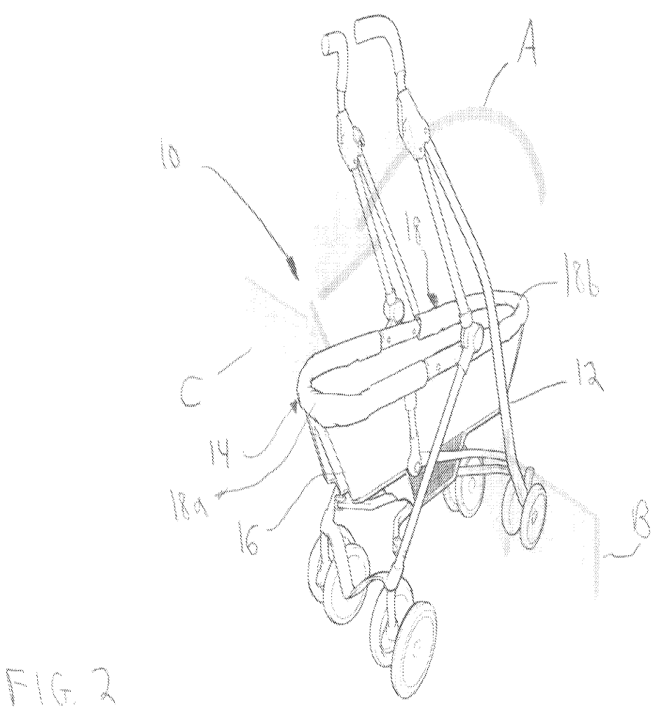

FIG. 2 shows the wagon stroller 10 being folded from an open position to a closed (i.e., folded) position. Arrows A, B and C show the directions in which force is applied to respective components of the wagon stroller 10 to fold it and thereby move it to the closed position. The collapsible member 18 facilitates this folding function (e.g., the inward/side-to-side folding of the wagon stroller 10 (i.e., Arrow C)). This folding function constitutes the 3D collapsing feature of the stroller.

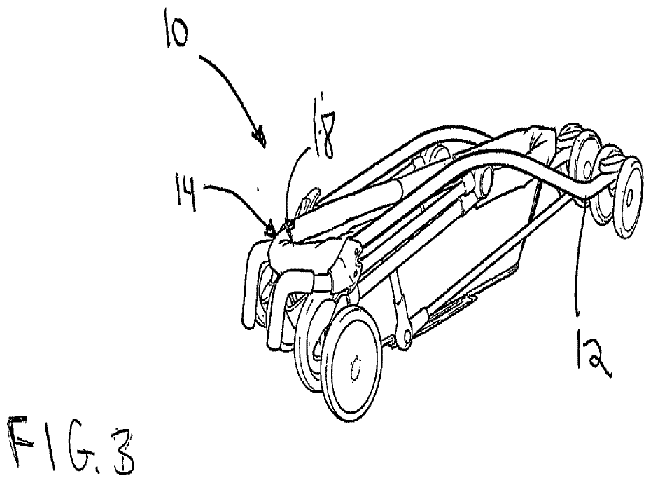

FIG. 3 shows the wagon stroller 10 in a closed (i.e., folded) position, which facilitates easy transport and storage/stowage.

The receptacle body/containment structure 14 and its sidewall 16 define a wagon-like space, and function as a wagon (e.g., wagons manufactured by/sold under the name Radio Flyer®). The wagon-like space can be used to transport two children (e.g., toddlers) in a face-to-face configuration, or one child and one pet (e.g., a dog), or only one child. The wagon-like space of the stroller need not be used to transport infants, toddlers or other children. The wagon-like space of the stroller can also be used exclusively for one or more pets, and/or for carrying inanimate objects/belongings/equipment (e.g., beach items, athletic equipment, etc.)

When not in use, being transported or stored/stowed, the stroller 10 can be folded and made more compact. The collapsible member 18 facilitates this folding function, as discussed above. Components of the stroller 10 discussed above are constructed from sturdy but lightweight materials, facilitating easy transportation, lifting and storage.

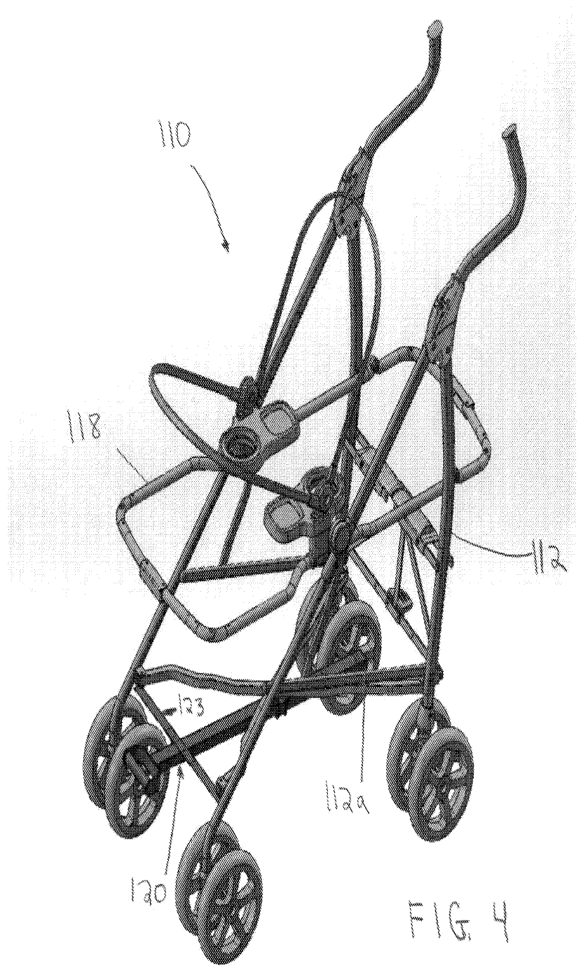

A wagon stroller according to another (i.e., second) embodiment of the invention is shown in FIGS. 4-6. This embodiment of the wagon stroller (denoted by reference number 110) is generally similar to that shown in FIGS. 1-3, having a frame 112, a collapsible member 118 and a receptacle body/containment structure (not shown for the sake of simplicity/clarity). The stroller 110 also includes a handle assembly 120 configured to pull the stroller 110 in a wagon fashion, as further discussed below.

As shown in FIGS. 4-6, the handle assembly 120 includes a first/outer member 122 having a first/rear end attached to the frame 112 at a lower, rear portion 112a thereof and a second/front end attached to a transverse member 123 of the frame 112 so that it extends in a longitudinal front-to-rear portion under the collapsible member 118.

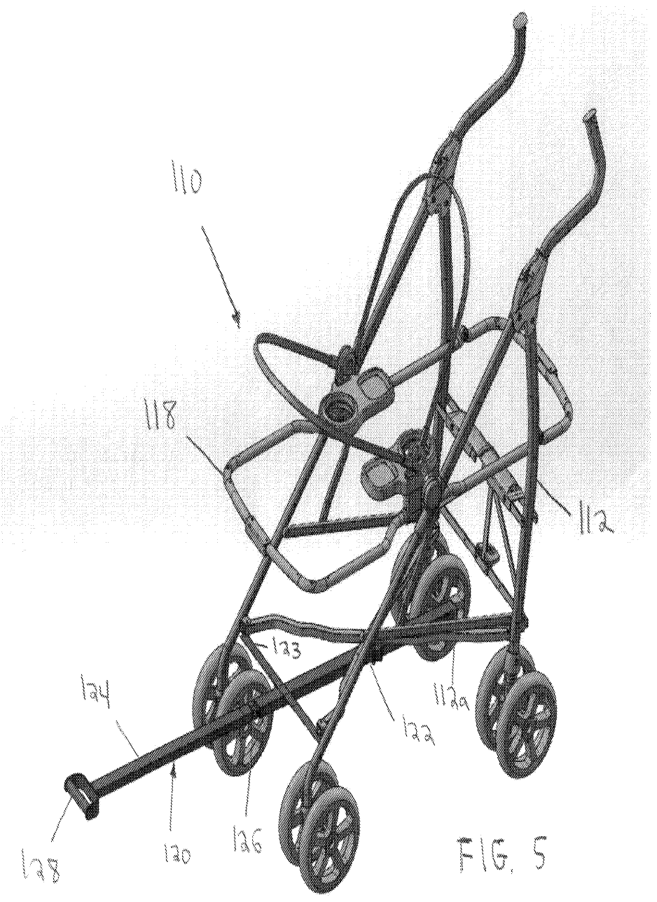

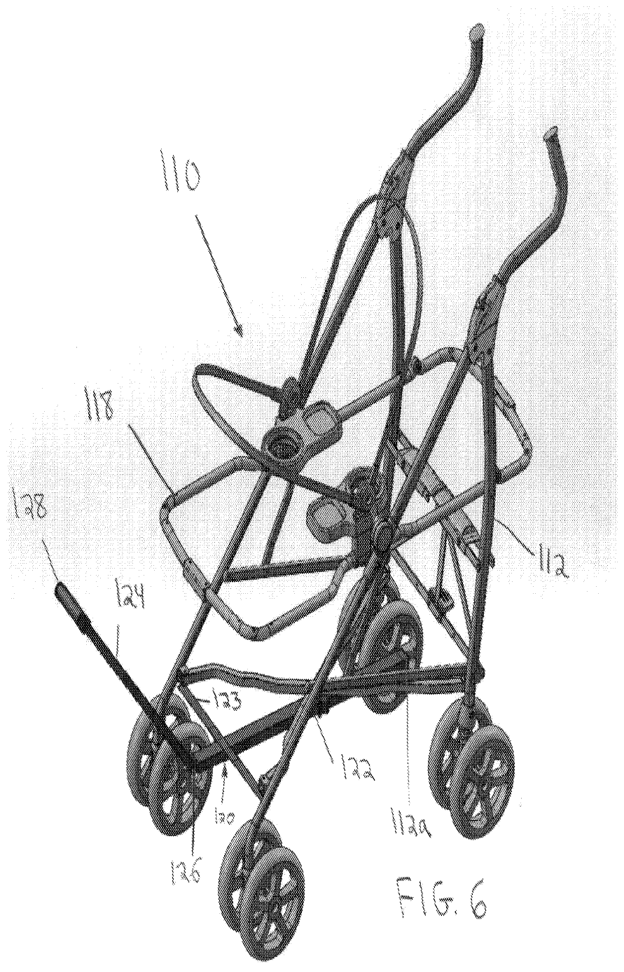

The handle assembly 120 further includes a second/inner member 124 that is dimensioned to telescopically engage the first/outer member 122, which is hollow and functions as a track tube. As shown in FIGS. 5 and 6, the second/inner member 124 includes a third/rear end that engages the first/outer member 122, and a fourth/front end having a handle 128 thereon. The second/inner member 124 also includes a hinge 126 between its third/rear and fourth/front ends.

FIG. 4 shows the handle assembly 120 in a stowed position, with second/inner member 124 contained within the first/outer member 122.

FIG. 5 shows the handle assembly 120 in a partially deployed position, wherein the second/inner member 124 has been pulled out of the first/outer member 122 (i.e., away from the frame 112) by a user to be colinear/in-line therewith, revealing the hinge 126. The hinge 126 allows the user to rotate the second/inner member 124 upwardly relative to the first/outer member 122.

FIG. 6 shows the handle assembly 120 in a fully deployed position, wherein the second/inner member 124 has been rotated and raised upwards to a pull height of the user, thereby enabling the user to pull the stroller 110 (and its contents) via the handle 128 of the handle assembly 120.

Once the user has completed the pulling activity, he or she can return the handle assembly 120 to its stowed position by simply reversing the above steps. The user rotatably lowers the handle 128 and second/inner member 124 to be colinear/in-line with the first/outer member 122 (i.e., the partially deployed position). The user then pushes the handle 128 towards the frame 112 to slide the second/inner member 124 into the first/outer member 122 so that the handle assembly 120 is returned to its stowed position.

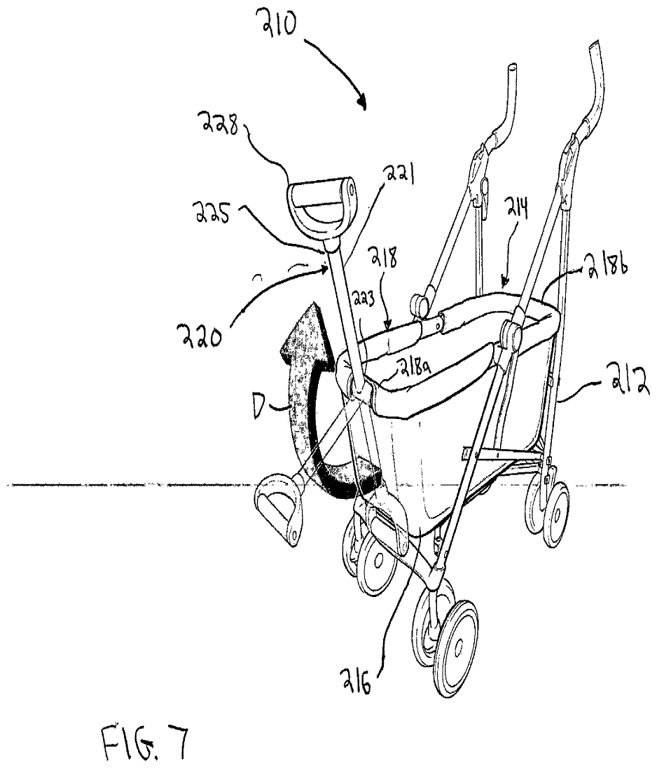

A wagon stroller according to another (i.e., third) embodiment of the invention is shown in FIG. 7. This embodiment of the wagon stroller (denoted by reference number 210) is generally similar to those shown in FIGS. 1-3 and 4-6, having a frame 212, a foldable receptacle body/containment structure 214 held by the frame 212 and having a generally oblong or rounded rectangular sidewall 216, and a collapsible member 218 having front and rear portions 218a, 218b. The stroller 210 also includes a handle assembly 220 configured to pull the stroller 210 in a wagon fashion, similar to the embodiment shown in FIGS. 4-6.

The handle assembly 220 includes a longitudinal member 221 having a first end 223 rotatably connected to the front portion 218a of the collapsible member 218 end (e.g., by a hinge (not shown) or other rotating means), and a second, free end 225 opposite the first end 223. The second end 225 has a handle 228 thereon.

In use, a user may rotate the handle assembly 220 upwardly from a stowed position in which the longitudinal member 221 is proximate to/in contact with the sidewall 216 to a deployed position in which the handle assembly 220 extends upwardly and away from the sidewall 216 (e.g., to a pull height of the user), as shown by Arrow D in FIG. 7. Once the user has completed the pulling activity, he or she can return the handle assembly 220 to its stowed position by rotating the handle assembly 220 downwardly until the longitudinal member 221 is again proximate to/in contact with the sidewall 216 again.

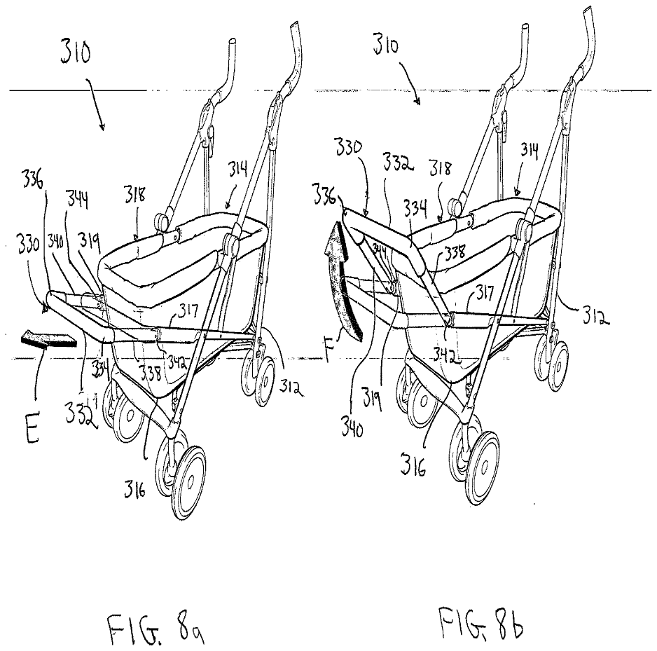

A wagon stroller according to another (i.e., fourth) embodiment of the invention is shown in FIGS. 8a and 8b. This embodiment of the wagon stroller (denoted by reference number 310) is generally similar to those shown in FIGS. 1-3, 4-6 and 7, having a frame 312, a foldable receptacle body/containment structure 314 held by the frame 312 and having a generally oblong or rounded rectangular sidewall 316, and a collapsible member 318. The frame 312 includes first and second generally hollow/tubular side rails 317, 319 that extend along the opposed sides of the sidewall 316 of the foldable receptacle body/containment structure 314. The stroller 310 also includes a sliding handle assembly 330 configured to pull the stroller 310 in a wagon fashion. The sliding handle assembly 330 includes a handle member 332 having opposed first and second ends 334, 336. The sliding handle assembly 330 further includes a first sliding member 338 having an end connected to the first end 334 of the handle member 332, and a second sliding member 340 having an end connected to the second end 336 of the handle member 332. The first sliding member 338 is dimensioned to telescopically engage the first side rail 317, which is hollow and functions as a track tube. Similarly, the second sliding member 334 is dimensioned to telescopically engage the second side rail 319, which is hollow and functions as a track tube. The first sliding member 338 also includes a hinge 342 distal to the first end 334 of the handle member 332.

Likewise, the second sliding member 340 also includes a hinge 344 distal to the second end 336 of the handle member 332.

FIG. 8a shows the sliding handle assembly 330 in a partially deployed position, wherein the first and second sliding members 338, 340 have been pulled out of the first and second side rails 317, 319, respectively, (i.e., away from the foldable receptacle body/containment structure 314) by a user to be colinear/in-line therewith via the handle member 332, as shown by Arrow E. Pulling out the first and second sliding members 338, 340 reveals the hinges 342, 344, which allow the user to rotate the first and second sliding members 338, 340 upwardly relative to the first and second side rails 317, 319.

FIG. 8b shows the sliding handle assembly 330 in a fully deployed position, having been rotated and raised upwards to a pull height of the user, as shown by Arrow F. The user is then able to pull the stroller 310 (and its contents) via the handle member 332 of the handle assembly 330.

Once the user has completed the pulling activity, he or she can return the handle assembly 330 to its stowed position by simply reversing the above steps. The user rotatably lowers the handle member 332 and first and second sliding members 338, 340, so that the first and second sliding members 338, 340 are colinear/in-line with the first and second side rails 317, 319 (i.e., the partially deployed position). The user then pushes the handle member 332 towards the foldable receptacle body/containment structure 314, sliding the first and second sliding members 338, 340 into the first and second side rails 317, 319, respectively, to return the handle assembly 330 to its stowed position.

In an alternate embodiment, the first and second members of the handle assembly do not telescope and slide into and out of the first and second side rails. Rather, the first and second members of the handle assembly are rotatably connected to the respective side rails, wherein a user can rotate the handle assembly upward to its fully deployed position for use, and rotate the handle assembly downward to its stowed position without telescoping.

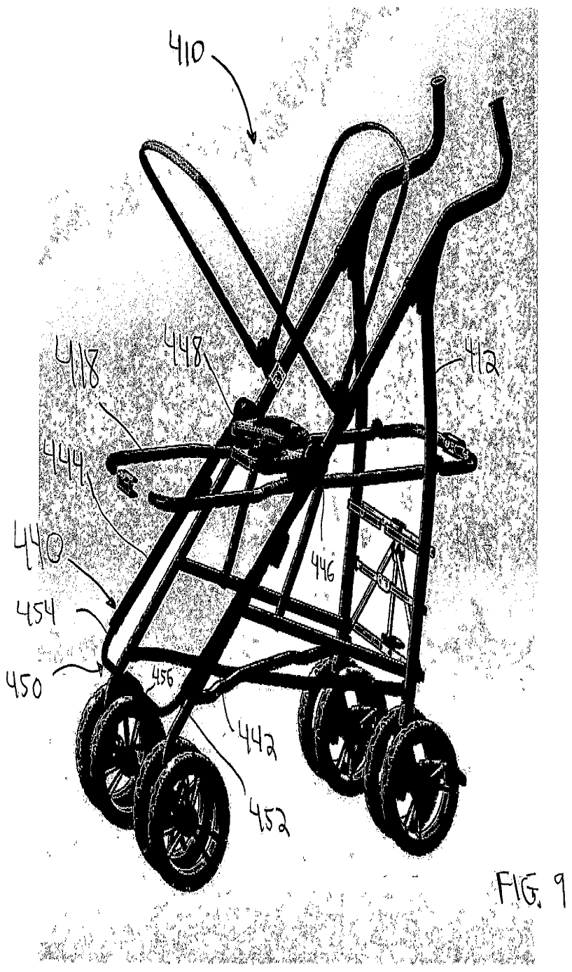

A wagon stroller according to another (i.e., fifth) embodiment of the invention is shown in FIGS. 9-11. This embodiment of the wagon stroller (denoted by reference number 410) is generally similar to those shown in FIGS. 1-8b, having a frame 412, a foldable receptacle body/containment structure (not shown for the sake of simplicity/clarity), and a collapsible member 418. The stroller 410 also includes a sliding handle assembly 440 configured to pull the stroller 410 in a wagon fashion, similar to the other embodiments of the present invention.

The sliding handle assembly 440 includes first and second generally hollow/tubular members 442, 444 that have respective ends 446, 448 rotatably connected (e.g., by hinges or other rotating means) to opposite sides of the frame 412, proximate the collapsible member 418. The hollow members 442, 444 may include rocker switches or other locking/release means to retain them in place. The sliding handle assembly 440 also includes a U-shaped handle member 450 having first and second sliding members 452, 454 and a handle member 456 extending between the first and second sliding members 452, 454 and distal the ends 446, 448 of the first and second hollow members 442, 444. The first sliding member 452 is dimensioned to telescopically engage the first hollow member 442. Similarly, the second sliding member 454 is dimensioned to telescopically engage the second hollow member 444.

The handle assembly 440 has a stowed (i.e., folded) position (as shown in FIG. 9) in which the handle assembly 440 extends along a portion of the frame 412 below/under the collapsible member 418.

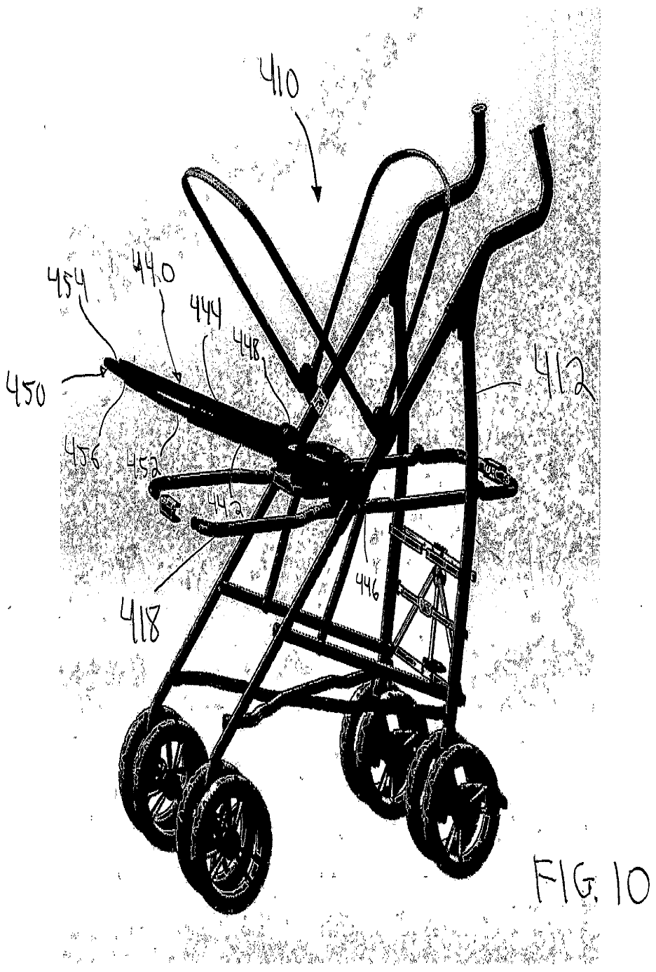

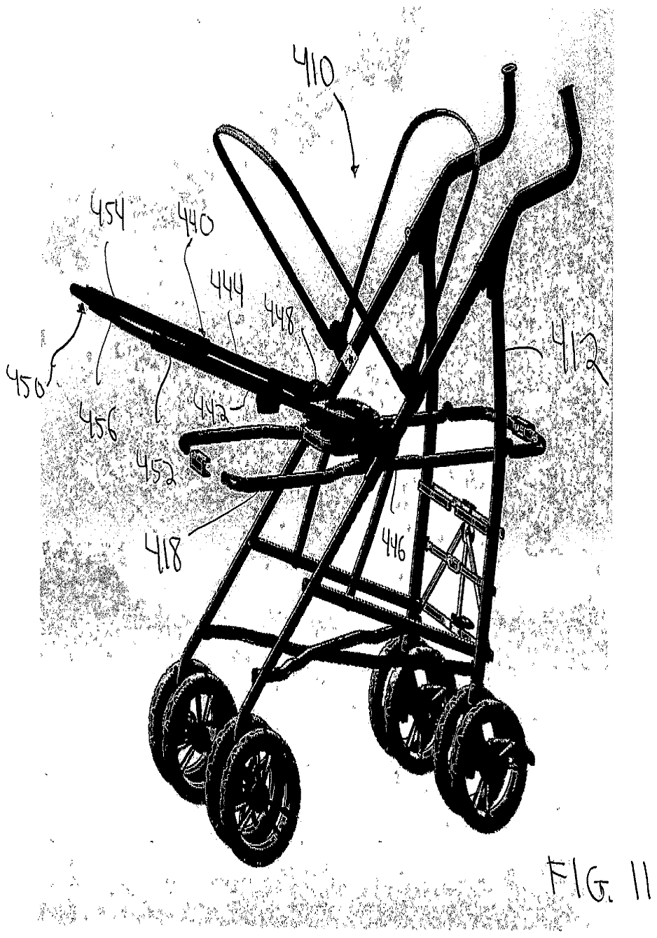

In use, a user rotates the handle assembly 440 upwardly from the stowed position to a partially deployed position (as shown in FIG. 10) in which the handle assembly 440 extends upwardly and away from the frame 412 above/over the collapsible member 418, at a pull height of the user. FIG. 11 shows the handle assembly 440 in a fully deployed position, wherein the user activates/unlocks the rocker switches (or similar means) on either side of the handle assembly 440, and pulls the first and second sliding members 452, 454 out of/away from the first and second hollow members 442, 444, respectively, (i.e., farther away from the frame 412) by the user pulling the handle member 456 away from the frame 412. The user is then able to pull the stroller 410 (and its contents) via the handle member 456 of the handle assembly 440.

Once the user has completed the pulling activity, he or she can return the handle assembly 440 to its stowed position by simply reversing the above steps. The user pushes the handle member 456 towards the frame 412, sliding the first and second sliding members 452, 454 into the first and second hollow members 442, 444, respectively. The user then rotates the handle assembly 440 downwardly until the handle assembly 440 extends along a portion of the frame 412 below/under the collapsible member 418 to return the handle assembly 440 to it in its stowed position.

In general, any combination of disclosed features, components and methods described herein is possible. Steps of a method can be performed in any order that is physically possible.

Although embodiments have been disclosed, the invention is not limited thereby.

We claim:

1. A stroller comprising:
a frame including a collapsible member, the collapsible member having a front portion and a rear portion; and
a foldable receptable body held by the frame;
wherein the stroller is movable between (1) a fully open position, (2) a partially-open position, and (3) a fully closed/folded position.

2. The stroller of claim 1, wherein the collapsible member is foldable.

3. The stroller of claim 1, wherein the front portion and rear portion of the collapsible member are segmented.

4. The stroller of claim 1, wherein the collapsible member is configured to facilitate an inwardly side-to-side folding of the stroller.

5. The stroller of claim 1, wherein the foldable receptable body includes a sidewall that defines a wagon-like space.

6. The stroller of claim 5, wherein the sidewall has a rounded rectangular shape.

7. The stroller of claim 1, further comprising a handle assembly attached to the frame, the handle assembly being configured to pull the stroller.

8. The stroller of claim 7, wherein the handle assembly includes an outer member and an inner member dimensioned to telescopically engage the outer member.

9. The stroller of claim 7, wherein the handle assembly is rotatably connected to the front portion of the collapsible member.

10. The stroller of claim 1, wherein the stroller is a folding stroller trifold.

11. A stroller comprising:
a frame including a collapsible member configured to facilitate an inwardly side-to-side folding of the stroller, the collapsible member having a segmented front portion and a segmented rear portion; and
a foldable receptable body held by the frame, the foldable receptable body including a sidewall that defines a wagon-like space;
wherein the stroller is movable between (1) a fully open position, (2) a partially-open position, and (3) a fully closed/folded position.

12. The stroller of claim 11, wherein the collapsible member is foldable.

13. The stroller of claim 11, further comprising a handle assembly attached to the frame, the handle assembly being configured to pull the stroller.

14. The stroller of claim 13, wherein the handle assembly includes an outer member and an inner member dimensioned to telescopically engage the outer member.

15. The stroller of claim 13, wherein the handle assembly is rotatably connected to the front portion of the collapsible member.

16. The stroller of claim 11, wherein the sidewall has a rounded rectangular shape.

17. The stroller of claim 11, wherein the stroller is a folding stroller trifold.

18. A stroller comprising:
a frame including a collapsible member configured to facilitate an inwardly side-to-side folding of the stroller, the collapsible member having a segmented front portion and a segmented rear portion;
a foldable receptable body held by the frame, the foldable receptable body including a sidewall that defines a wagon-like space; and
a handle assembly attached to the frame, the handle assembly being configured to pull the stroller;
wherein the stroller is movable between (1) a fully open position, (2) a partially-open position, and (3) a fully closed/folded position.

19. The stroller of claim 18, wherein the collapsible member is foldable.

20. The stroller of claim 18, wherein the handle assembly is rotatably connected to the front portion of the collapsible member.
